(19) United States
(12) Patent Application Publication
(10) Pub. No.: US 2003/0001879 A1
(43) Pub. Date: Jan. 2, 2003

(54) Picture management method that simulates uses and operations of a physical photo album

(76) Inventors: Kuang-Shin Lin, Taipei (TW); Sayling Wen, Taipei (TW); Jie Sun, Tianjin (CN)

Correspondence Address: BIRCH STEWART KOLASCH & BIRCH, PO BOX 747, FALLS CHURCH, VA, 22040-0747, US

(21) Appl. No.: 10/183,154

(22) Filed: Jun. 28, 2002

(30) Foreign Application Priority Data
Jun. 29, 2001 (TW) 90115897

(51) Int. Cl. G09G 5/00

(52) U.S. Cl. 345/716

(57) ABSTRACT

A picture management method that simulates uses and operations of a physical photo album is disclosed. It is a utility within an OS that can operate with different OS's. A user can perform a desired operation with a single action using the UOI provided by the invention. Through browsing, copying, adding, deleting, and renaming functions for picture files, the invention achieves the goal of picture management. The disclosed method includes at least the steps of receiving a request signal from the user, analyzing the request signal through an album manager, and selecting a processing mode according to the request signal.

### BACKGROUND OF THE INVENTION

1. Field of Invention

The invention relates to an OS (Operating System) and, in particular, to a picture management method that can operate with other different OS's and can simulate uses and operations of a physical photo album.

2. Related Art

With the increase in computer popularity, people often need to use computers to solve problems either at work or at home. But there are some causes that still produce the difficulty for people to manage picture files. One can see the causes in the following points:

1. Existing personal computer OS's (Operating System), such as MS Windows, Linux, and so on, are complicated despite of their powerful functions and designs. Moreover, the user operation designs are not intuitive and simple enough. This situation scares people without any computer background because of the obstacles they meet while using these systems.

2. The conventional management method of picture files still inherits such concepts as files, folders, and paths for normal computer documents. The drawback is that for most beginning users, such a method does not have an intuitive correspondence with real daily experiences. The “SAVE” and “LOAD” operations are also relatively abstract.

Because of the above, it is thus highly desirable to provide a simple and convenient OS to solve the problem.

### SUMMARY OF THE INVENTION

In view of the foregoing, the invention provides a picture management method that simulates uses and operations of a physical photo album. The method is based on a one-touch OS, whose main objective is to use a finite number of keys as the hot keys to achieve the operations of various functions. In this OS, each function is initiated by a single key, thus implementing convenience and intuition of operations and increasing users' interest in using computers.

Based upon the one-touch principle, it is of benefit to provide a management method for simulating uses and operations of a physical photo album that allows users to operate in a concept similar to daily life (not computers) so that the user can experience the “WYTIWYG (What-You-Think-Is-What-You-Get)” effects. For example, if the user wants to duplicate a picture on a computer, he only needs to select a picture from a picture list area in a picture copying interface, and then selects a target album from an album list area. This totally realizes the “inserting a designated picture to a designated photo album” natural process in real life.

In accordance with the above advantages, any computer featured with the disclosed picture management method enables the user to conveniently and quickly manage pictures. Such extra benefits can further facilitate computer sales and uses.

The invention includes at least the steps of: receiving a request signal from the user, analyzing the request signal through an album manager, and selecting a processing mode according to the request signal.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of the prior art;

FIG. 2 is a schematic view showing the disclosed picture management method that simulates uses and operation of a physical photo album;

FIG. 3-a is a flowchart of the operation steps in the method shown in FIG. 2;

FIG. 3-b is a flowchart showing the BROWSE operation in the method shown in FIG. 2;

FIG. 3-c is a flowchart showing the ADD operation in the method shown in FIG. 2;

FIG. 3-d is a flowchart showing the COPY operation in the method shown in FIG. 2;

FIG. 3-e is a flowchart showing the DELETE operation in the method shown in FIG. 2;

FIG. 3-f is a flowchart showing the RENAME operation in the method shown in FIG. 2;

FIG. 4 is a picture showing the interface window of the disclosed method;

FIG. 5 is another picture showing the interface window of the disclosed method; and

FIG. 6 is yet another picture showing the interface window of the disclosed method.

### DETAILED DESCRIPTION OF THE INVENTION

The invention proposes a picture management method that simulates uses and operations of a physical photo album. In particular, in contrast to currently available complicated OS's, a convenient and intuitive UOI (User Operating Interface) is provided herein so that the user can complete a desired effect through a single hot key on a keyboard. Through the network linkage, the user can achieve the goal of browsing, copying, adding, deleting, and renaming a picture file through the one-touch OS.

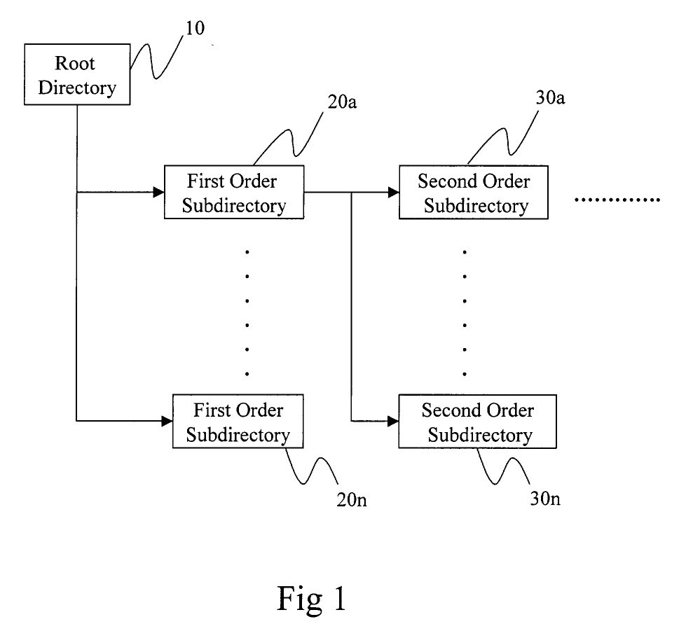

A preferred embodiment is given below to demonstrate the feasibility of the disclosed method. As shown in FIG. 1, conventionally picture files are managed using a tree structure. To find a picture file, the user has to search for a first order subdirectory 20a from the root directory 10, and a second order subdirectory 30a from the first order subdirectory 20a, and so on until the desired file is found. If the user cannot find the file through this particular path, he has to return to the previous order subdirectory to search again. This method results in great inconvenience for users.

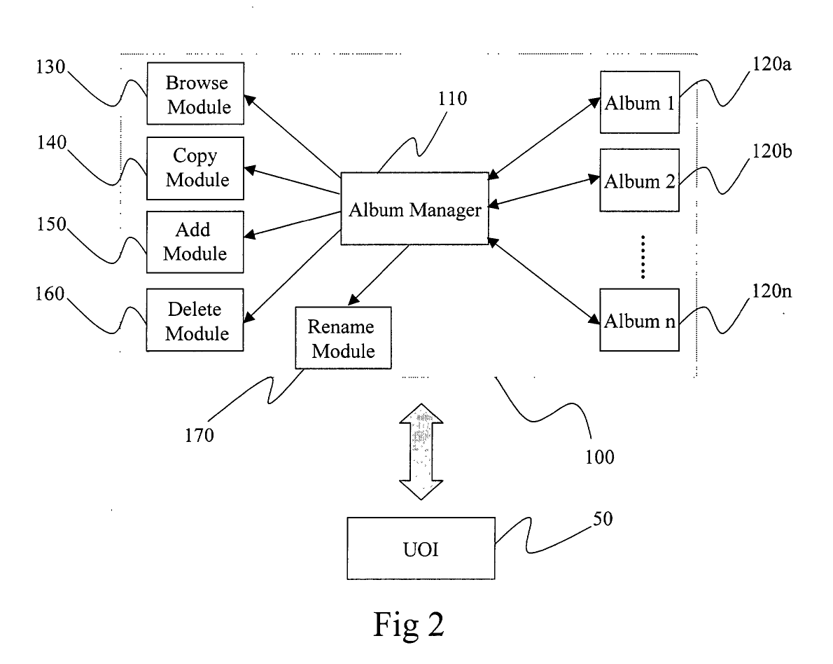

With reference to FIG. 2, the disclosed method processes the procedure arranged in the one-touch OS 100, generates different UOI's, and performs browsing, copying, adding, deleting, and renaming picture files. When a user enters an album manger provided by the one-touch OS 100, the procedure in the system starts and links albums 120a˜n. Each of the albums 110 contains a browse module 130, a copy module 140, an add module 150, a delete module 160, and a rename module 170.

1. The browse module 130 is used to browse all picture files stored in an external storage medium 180 and an internal storage medium 185.

2. The copy module 140 copies the picture files in the external storage medium 180 and the internal storage medium 185 to a register 190 and finally stores them in the internal storage medium 185.

3. The add module 150 adds at least one picture file to the internal storage medium 185 from the external storage medium 180.

4. The delete module 160 deletes at least one picture file from the internal storage medium 185.

5. The rename module 170 renames the filename of a picture file or an album.

The one-touch OS 100 refers to an OS that enables a user to complete a function provided in the work group displayed in an interface generating module 150 in one action. The work group is comprised of at least one function item. The one-touch OS 100 can operate with other different OS's or alone. The user chooses to switch among the different OS's.

The one-touch OS 100 can run on any computer controlled hardware platform, such as a PC (Personal Computer), an NB (Notebook), and a PDA (Personal Digital Assistant). Any person skilled in the art can make various modifications and implement the disclosed fax control mechanism 110 in any electronic device that can establish communications with a network.

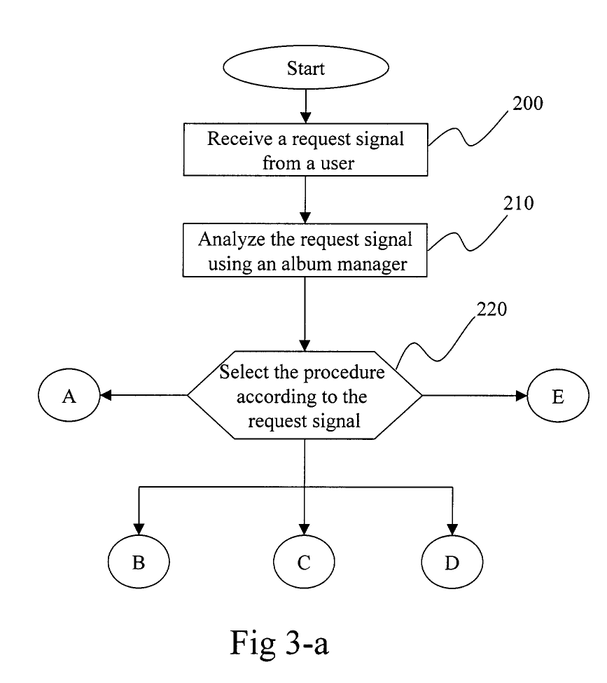

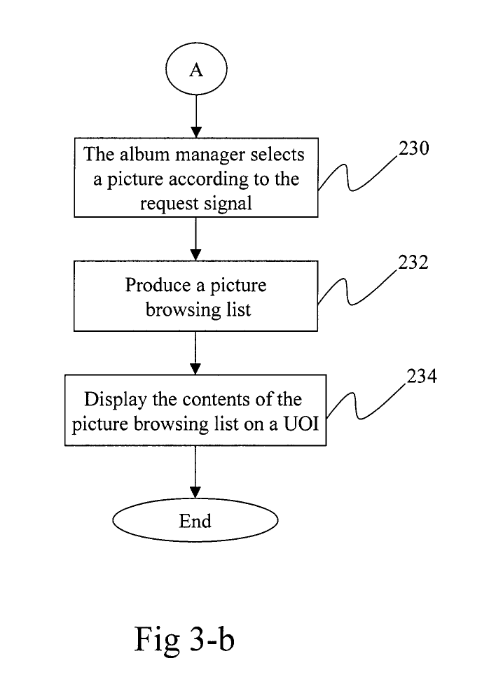

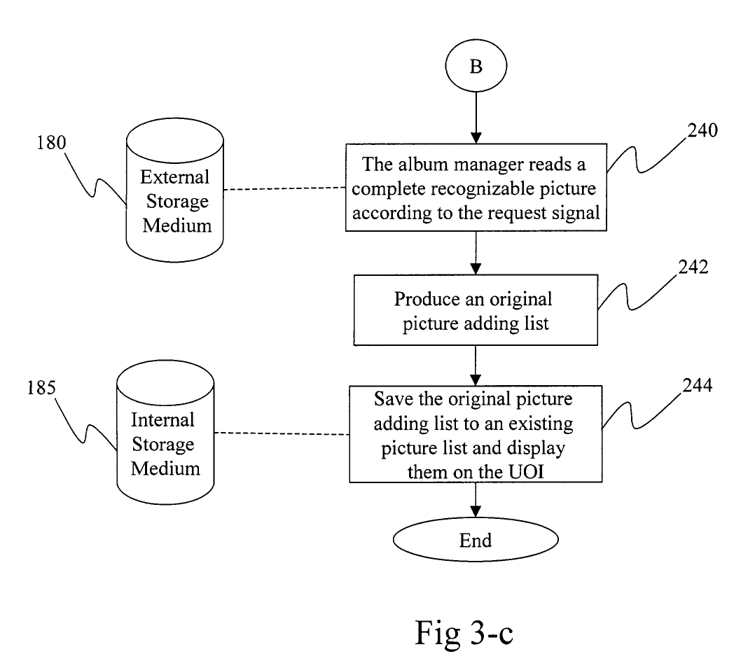

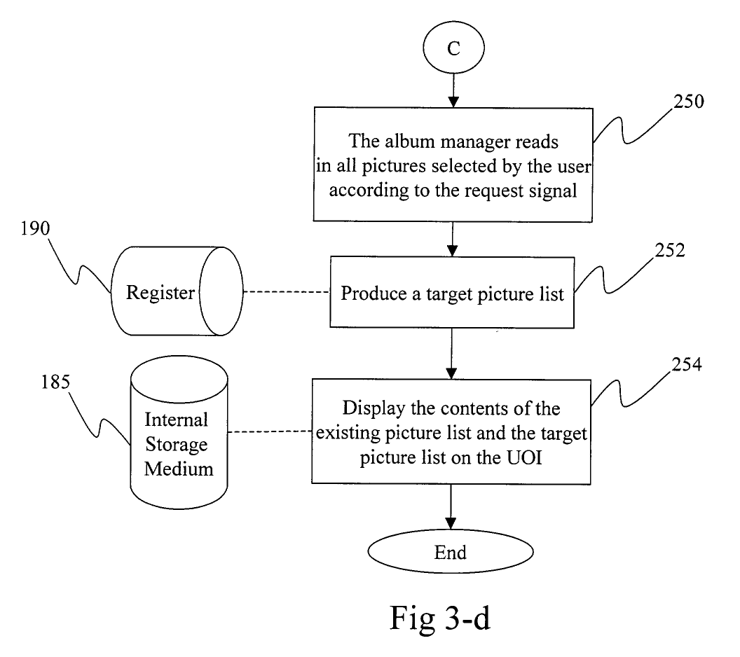

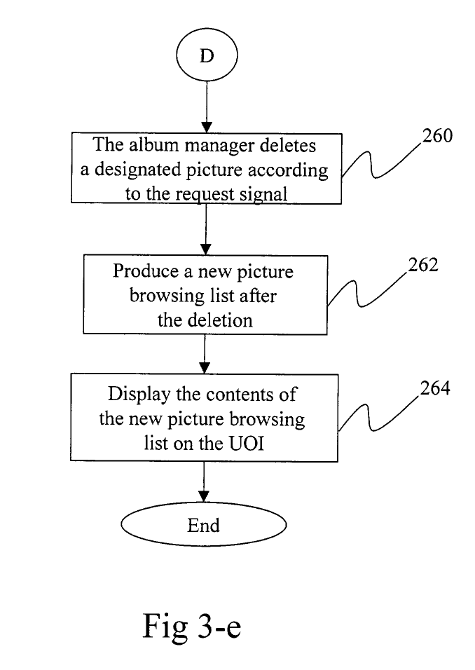

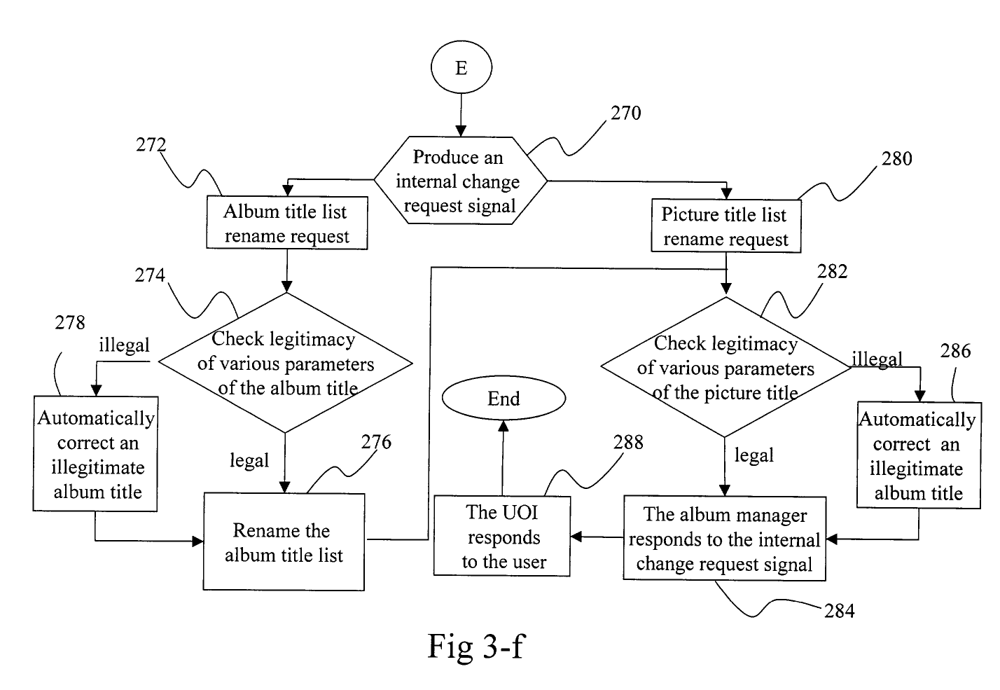

FIG. 3-a explains the main procedure of the invention. First the album manager 110 receives a request signal from a user (step 200). The album manger 110 analyzes the request signal (step 210). Afterwards, the request signal is used to select a procedure from steps A, B, C, D, and E (step 220).

FIG. 3-b demonstrates detailed steps in step A. First, the album manager 110 invokes a picture according to the request signal (step 230). This picture can be invoked from both the external storage medium 180 and the internal storage medium 185. Afterwards, the album manager 110 produces a picture browsing list (step 232). The contents of the picture browsing list are displayed on a UOI 50 (step 234). The user can thus directly browse the pictures.

FIG. 3-c demonstrates detailed steps in step B. First, the album manager 110 reads a whole recognizable picture according to the request signal (step 240). The recognizable picture is stored in an external storage medium 180. An original picture adding list is produced (step 242). Finally, the original picture adding list is saved to an existing picture list and all of them are displayed on the UOI 50 (step 244). The existing picture list is stored in the internal storage medium.

FIG. 3-d demonstrates detailed steps in step C. First the album manager 110 reads in all picture data selected by the user according to the request signal (step 250). A target picture list is then produced (step 252). The target picture list is stored in a register 190 so as to prevent losing the path and resulting in system errors during the picture copying procedure. That is, the pictures to be copied are stored in the target picture list. The existing picture list and the target picture list are simultaneously displayed on the UOI 50 (step 254).

FIG. 3-e demonstrates detailed steps in step D. The album manager 110 deletes a designated picture according to the request signal (step 260) and produces a new picture browsing list after the deletion (step 262). Finally, the contents in the new picture browsing list are displayed on the UOI 50.

FIG. 3-f demonstrates detailed steps in step E. An internal change request signal is produced (step 270). The album manager 110 provides two rename requests: one is the album title list rename request (step 272) and the other is the picture title rename request (step 280). After step 272, the legitimacy of various parameters in the album title is checked (step 274). If they are legitimate, then the album title list is updated and a new picture list is ensured (step 276). If they are illegitimate, then a correction is automatically made for the illegitimate album title (step 278), restoring to the previous name to avoid system errors. After step 280, the legitimacy of various parameters in the picture title is checked (step 282). If they are legitimate, then the album manager responds to the internal change request signal (step 284). If they are illegitimate, then a correction is automatically made for the illegitimate picture title (step 286), restoring to the previous name to avoid system errors. Finally, the UOI 50 responds to the user request (step 288).

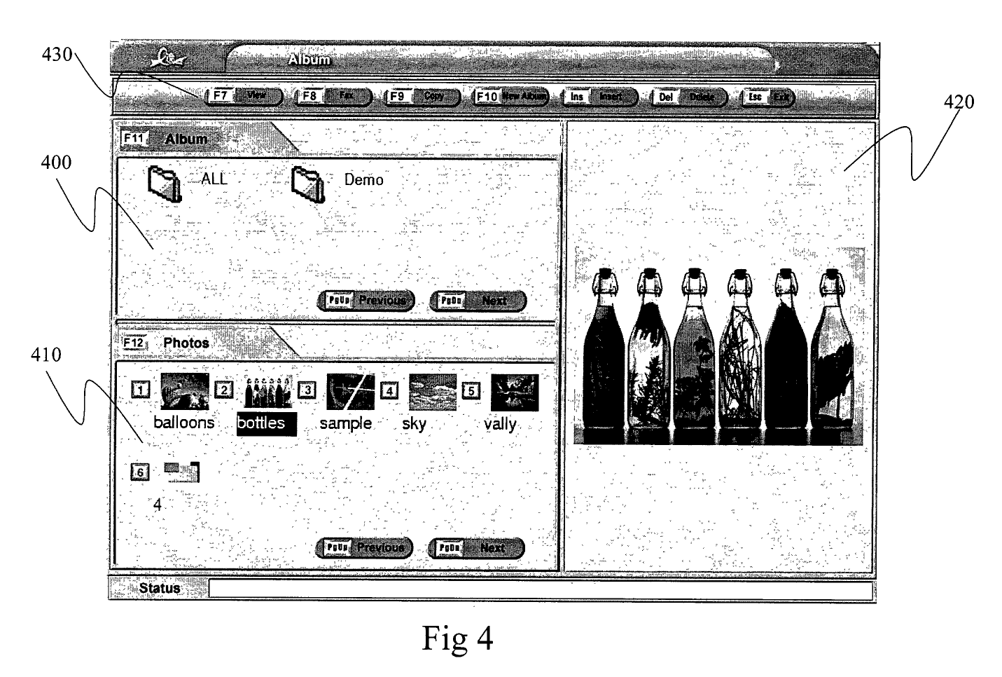

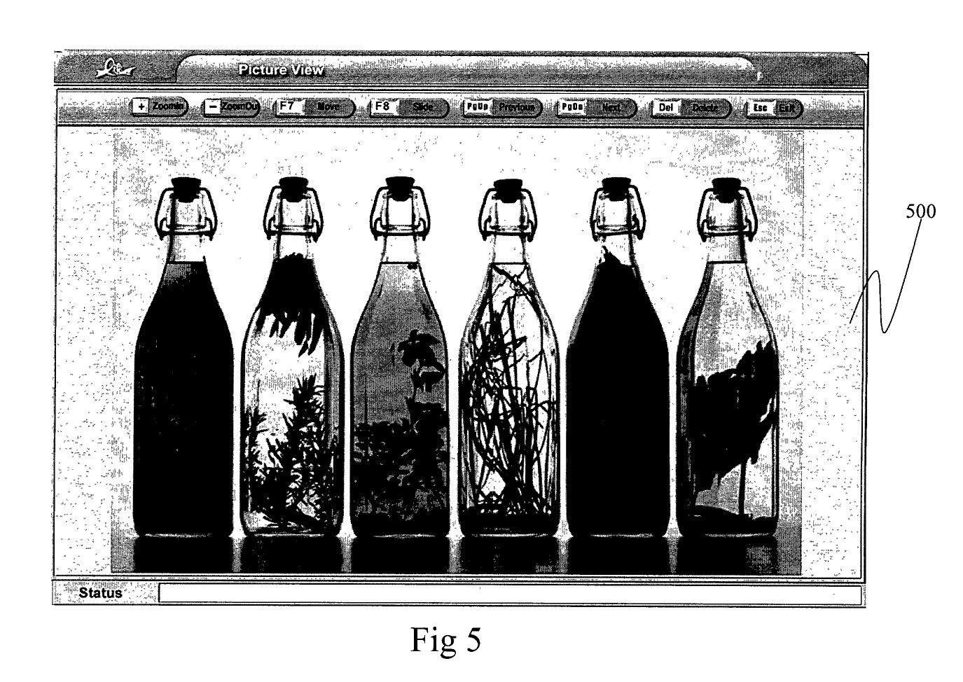

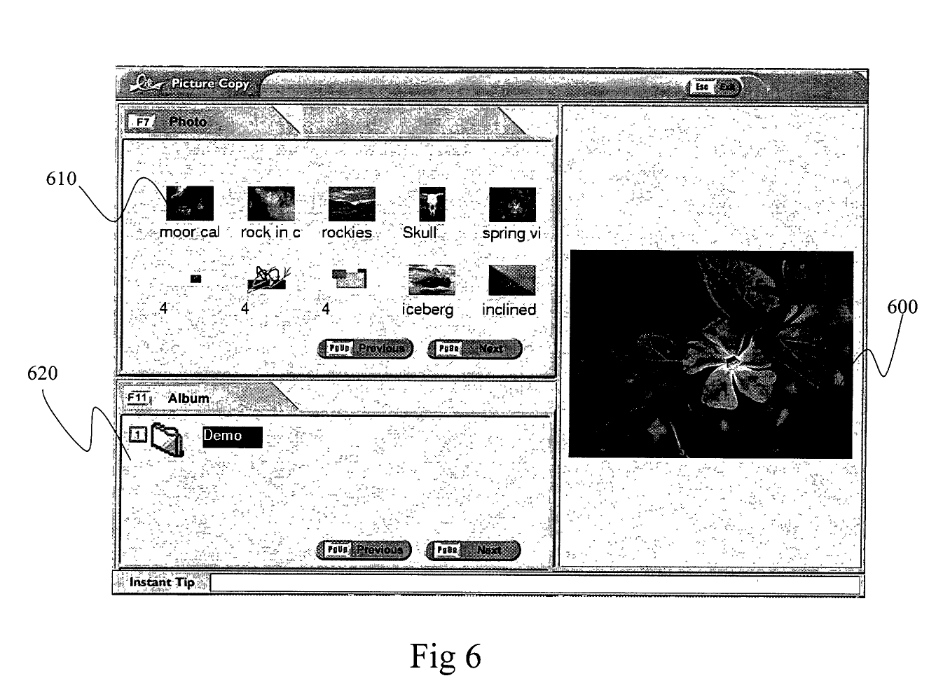

Please refer to FIGS. 4, 5, and 6. Through the picture management interface window, the user can follow the hints on the interface window to select a desired function item. For the current embodiment, the user can have picture preview 420 on a particular picture selected from an album list area 400 and a picture list area 410. Once a picture is selected, the user can enter a picture viewing interface 500 through a function list area 430. If the user wants to copy pictures, he can have a picture preview 600 for an original picture list 610 and then copies a particular picture to a target album list 620. In other words, the user does not need to perform extra system settings and file saving actions. Simply hitting one key allows the user to perform a specific job. Therefore, the user can use the services provided by the computer in a more intuitive way, increasing beginner user's will to use computers.

In the current embodiment, the single action offered by the one-touch OS 100 means that the user can directly hit one key on the keyboard according to a selection menu to enter his request. Any key on the keyboard can be set to complete this kind of actions. The keys include the number keys 0˜9, the letter keys A˜Z, the function keys F1˜F12 and special keys ESC, TAB, PgUp, END, etc. Aside from the keyboard, the single action request input can be accomplished using a mouse or other controllers, such as the digital touch-control panel and the voice recognition system. That is, any basic input device for the computer can be used to provide the one-touch control.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A picture management method simulating uses and operations of a physical photo album, which is used in a one-touch OS (Operating System) running on a computer controlled hardware platform to manage picture files where a user uses a UOI (User Operating Interface) to perform controls and an album manager to monitor procedures, the method comprising the steps of:
receiving a request signal from the user;
using the album manager to analyze the request signal; and
selecting a processing method according to the request signal.

2. The method of claim 1, wherein the one-touch OS is an OS that enables a user to complete a function provided in the work group displayed in an interface generating module 150 in one action.

3. The method of claim 2, wherein the work group is comprised of at least one function item.

4. The method of claim 2, wherein the single action refers to the action that the user follows a selection menu generated by the UOI to perform controls using a basic I/O (Input/Output) device provided by the computer controlled hardware platform.

5. The method of claim 4, wherein the basic I/O device is selected from the group comprising a keyboard, a mouse, a digital touch-control panel and a voice recognition system.

6. The method of claim 2, wherein the UOI generates at least one set of the work group.

7. The method of claim 1, wherein the one-touch OS is able to operate with other different OS's and the user determines to switch among the different OS's.

8. The method of claim 1, wherein the one-touch OS operates alone.

9. The method of claim 1, wherein the computer controlled hardware platform is selected from the group comprising a PC (Personal Computer), an NB (Notebook), and a PDA (Personal Digital Assistant).

10. The method of claim 1, wherein the step of selecting a procedure according to the request signal includes the following function items: BROWSE, ADD, COPY, DELETE, and RENAME.

11. The method of claim 10, wherein processing the request signal using the BROWSE function item further comprises the steps of:
Selecting a picture using the album manager according to the request signal;
producing a picture browsing list; and
displaying the contents of the picture browsing list on the UOI.

12. The method of claim 10, wherein processing the request signal using the ADD function item further comprises the steps of:
reading a complete recognizable picture using the album manager according to the request signal;
producing a original picture adding list; and
saving the original picture adding list to an existing picture list and displaying them on the UOI.

13. The method of claim 12, wherein the complete recognizable picture is stored in an external storage medium.

14. The method of claim 12, wherein the existing picture list originally exists in an internal storage medium of the computer controlled hardware platform.

15. The method of claim 10, wherein processing the request signal using the COPY function item further comprises the steps of:
reading all pictures selected by the user using the album manager according to the request signal;
producing a target picture list; and
displaying the contents of an existing picture list and the target picture list on the UOI.

16. The method of claim 15, wherein the target picture list is stored in a register.

17. The method of claim 15, wherein the existing picture list originally exists in an internal storage medium of the computer controlled hardware platform.

18. The method of claim 10, wherein processing the request signal using the DELETE function item further comprises the steps of:
deleting a designated picture using the album manager according to the request signal;
producing a new picture browsing list after the deletion; and
displaying the contents of the new picture browsing list on the UOI.

19. The method of claim 10, wherein processing the request signal using the COPY function item further produces an internal change request signal that includes: an album title list rename request and a picture title list rename request.

20. The method of claim 19, wherein the album title list rename request further comprises the steps of:
checking legitimacy of various parameter of the album title;
renaming the album title list;
automatically correcting a correction to an illegitimate album title; and
responding the user through the UOI.

21. The method of claim 19, wherein the picture title list rename request further comprises the steps of:
checking legitimacy of various parameter of the picture title;
responding the internal change request signal using the album manager;
automatically correcting a correction to an illegitimate album title; and
responding the user through the UOI.
